(19) United States
(12) Patent Application Publication
(10) Pub. No.: US 2012/0169963 A1
(43) Pub. Date: Jul. 5, 2012

(54) LIQUID CRYSTAL DISPLAY APPARATUS

(75) Inventor: Jeong Min Park, Yongin-city (KR)

(73) Assignee: SAMSUNG MOBILE DISPLAY CO., LTD., Yongin-city (KR)

(21) Appl. No.: 13/226,673

(22) Filed: Sep. 7, 2011

(30) Foreign Application Priority Data
Dec. 29, 2010 (KR) 10-2010-0138058

(51) Int. Cl. G02F 1/1335

(52) U.S. Cl. 349/62

(57) ABSTRACT

Provided is a liquid crystal display device. The liquid crystal display device includes a packaging tape assembling a liquid crystal display panel to a backlight unit. The packaging tape surrounds at least a portion of top and side surfaces of the liquid crystal display panel and a side surface of the backlight unit.

### CROSS-REFERENCE TO RELATED APPLICATIONS

This U.S. non-provisional patent application claims priority under 35 U.S.C. §119 of Korean Patent Application No. 10-2010-0138058, filed on Dec. 29, 2010, the entire contents of which are hereby incorporated by reference.

### BACKGROUND

1. Field

The present disclosure relates to a display device, and more particularly, to a liquid crystal display device.

2. Description of the Related Technology

With the rapid development of information society, there is a demand for flat panel display devices having excellent characteristics, such as slim profile, lightweight and low power consumption. Some such flat panel displays include a liquid crystal display device or an organic light-emitting device.

The liquid crystal display device includes a backlight unit and a liquid crystal display panel. The backlight unit and the liquid crystal display panel may be assembled by a mold frame. However, when the mold frame is used, manufacturing costs of the liquid crystal display device may be increased. In addition, since the mold frame is used, the lightweight and slim profile of the liquid crystal display device may be hindered.

### SUMMARY

The present disclosure provides a liquid crystal display device having a slim profile and improved strength.

Embodiments provide liquid crystal display devices including: a liquid crystal panel; a backlight unit under the liquid crystal panel; and a packaging tape assembling the liquid crystal display panel and the backlight unit, wherein the packaging tape surrounds at least a portion of top and side surfaces of the liquid crystal display panel and a side surface of the backlight unit.

In some embodiments, the packaging tape may cover the entire top surface of the liquid crystal display panel.

In other embodiments, the packaging tape may include: a first optical adhesive adhering to the liquid crystal display panel and the backlight unit; and an optical film on the first optical adhesive.

In still other embodiments, the liquid crystal display devices may further include a light shielding print part adhering to the packaging tape, the light shielding print part covering an edge of the top surface of the liquid crystal display panel.

In even other embodiments, the light shielding print part may include a white print part on the optical film, and a black print part on the white print part.

In yet other embodiments, the light shielding print part may extend from the edge of the top surface of the liquid crystal display panel to cover both side surfaces of the liquid crystal display panel.

In further embodiments, the liquid crystal display devices may further include a second optical adhesive disposed on the optical film.

In still further embodiments, the packaging tape may extend from a side surface of the backlight unit to adhere to at least portion of a rear surface of the backlight unit.

In even further embodiments, the liquid crystal display devices may further include a chassis configured to assemble the backlight unit and the liquid crystal display device.

In much further, the packaging tape may be disposed between the chassis and the backlight unit, and between the chassis and the liquid crystal display panel.

In still much further, the backlight unit may include: a light source; a light guide plate on which the light source is assembled; a reflection sheet disposed on a back surface of the light guide plate; and an optical sheet on the light guide plate.

In even much further, the light source may include a light emitting diode.

### BRIEF DESCRIPTION OF THE DRAWINGS

The accompanying drawings are included to provide a further understanding of the present invention, and are incorporated in and constitute a part of this specification. The drawings illustrate certain embodiments of the present invention and, together with the description, serve to explain principles of the inventive concept. In the drawings:

FIG. 1 is an exploded perspective view of an embodiment of a liquid crystal display device;

FIG. 2A is a sectional view of an embodiment of a liquid crystal display device;

FIG. 2B is a sectional view of an embodiment of a process in which a liquid crystal display panel and a backlight unit are assembled using a packaging tape;

FIG. 3 is a sectional view of another embodiment of a liquid crystal display device;

FIG. 4 is a sectional view of another embodiment of a liquid crystal display device; and

FIG. 5 is a sectional view of another embodiment of a liquid crystal display device.

### DETAILED DESCRIPTION

Objectives, characteristics and advantages of the inventive concept will be easily understood from embodiments that will be described in detail below by reference to the attached drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

In the specification, it will be understood that when an element is referred to as being ‘on’ another element or substrate, it can be directly on the other element, or intervening elements may also be present. Like reference numerals generally refer to like elements throughout.

In the specification, embodiments in the detailed description will be described with sectional views as example views. In the figures, the dimensions of layers and regions may be exaggerated for clarity of illustration. Accordingly, shapes of the example views may be modified according to manufacturing techniques and/or allowable errors. Therefore, embodiments are not limited to the specific shape illustrated in the example views, but may include other shapes that may be created according to manufacturing processes. Areas exemplified in the drawings have general properties, and are used to illustrate a specific shape of a semiconductor package region. Thus, this should not be construed as limited to the scope of the present invention. It will be understood that although the terms first, second, and third are used herein to describe various elements, these elements should not be limited by these terms. An embodiment described and exemplified herein includes a complementary embodiment thereof.

In the following description, the technical terms are used only for explaining specific embodiments while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

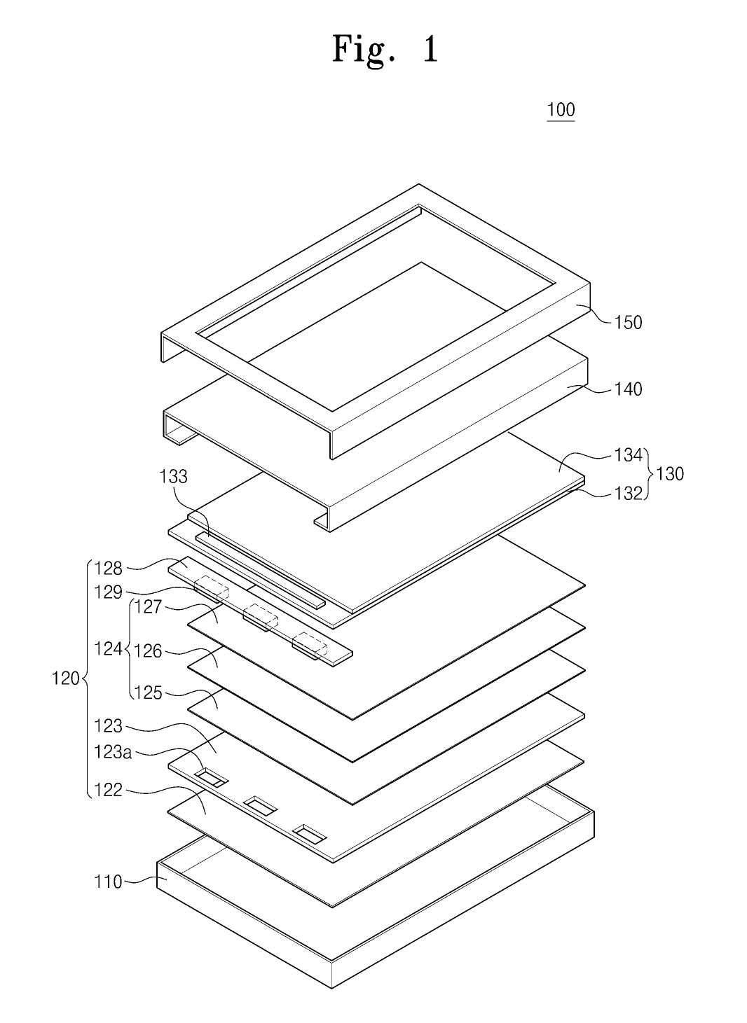

FIG. 1 is an exploded perspective view of an embodiment of a liquid crystal display device.

Referring to FIG. 1, an embodiment of a liquid crystal display device 100 may include a liquid crystal display panel 130, a backlight unit 120 disposed on a back surface of the liquid crystal display panel 130, and a packaging tape 140 for assembling the liquid crystal display panel 130 and the backlight unit 120. The packaging tape 140 may surround top and side surfaces of the liquid crystal display panel 130 and a side surface of the backlight unit 120.

The liquid crystal display panel 130 may include a lower substrate 132 and an upper substrate 134, which face each other. A liquid crystal layer (not shown) may be disposed between the lower substrate 132 and the upper substrate 134. A polarizer (not shown) may be disposed on at least one surface of the lower substrate 132 and the upper substrate 134. A driving chip 133 for driving the liquid crystal display panel 130 may be mounted on a side of the lower substrate. The liquid crystal display panel 130 may display corresponding information on a screen according to the operation of the liquid crystal layer.

The backlight unit 120 may have a structure which provides light for display information on the liquid crystal display panel 130. Specifically, the backlight unit 120 may include a light source 129, a light guide plate 123 on which the light source 129 is assembled, a reflection sheet 122 disposed under the light guide plate 123, and an optical sheet 124 disposed on the light guide plate 123.

The light source 129 may be mounted on a printed circuit board (PCB) 128. The PCB 128 may be formed of a flexible material. The light source 129 may include a light emitting diode. The light source 129 may supply light required for display image information on the liquid crystal display panel 130. In other embodiments, the light source 129 may include a fluorescent lamp, such as, for example, a cold cathode fluorescent lamp (CCFL).

The light guide plate 123 may convert point light supplied from the light source 129 into surface light. The light guide plate 123 may include grooves 123a in which the light source is assembled. The light guide plate 123 may be formed of a material which disperses the point light and has superior transmittance. In some embodiments, the light guide plate 123 may be formed of a material which has high strength and is not easily deformable. In some embodiments, the light guide plate 123 may be formed of poly methyl meta acrylate (PMMA).

The reflection sheet 122 is disposed under the light guide plate 123. The reflection sheet 122 may prevent light from leaking into the back surface of the light guide plate 123. The reflection sheet 122 may reflect light incident into the back surface of the light guide plate 123 toward the liquid crystal display panel 130. In some embodiments, the reflection sheet 122 may be formed of polyethylen terephthalate (PET) or polycarbonate.

The optical sheet 124 may be disposed between the light guide plate 123 and the liquid crystal display panel 130. The optical sheet 124 may include a diffusion sheet 125, a prism sheet 126, and a protection sheet 127, which are sequentially stacked. The diffusion sheet 125 may disperse light emitted from the light guide plate 123. The emitted light may be uniformly transferred onto the liquid crystal display panel 30 by the diffusion sheet 125.

The prism sheet 126 may collect the light dispersed by the light guide plate 123 and the diffusion sheet 125 to improve light luminance. The prism sheet 126 may be provided in plurality. One of the prism sheets 126 may collect light, and the other one of the prism sheets 126 may improve collimation of light. The protection sheet 127 may prevent the optical sheet 124 from being damaged by external impacts or introduction of foreign substances.

In some embodiments, the liquid crystal display device 100 may further comprise a chassis 110 in which the backlight unit 120 and the liquid crystal display panel 130 are assembled. The chassis 110 may be formed of a metal. The chassis 110 may improve the strength of the liquid crystal display device 100.

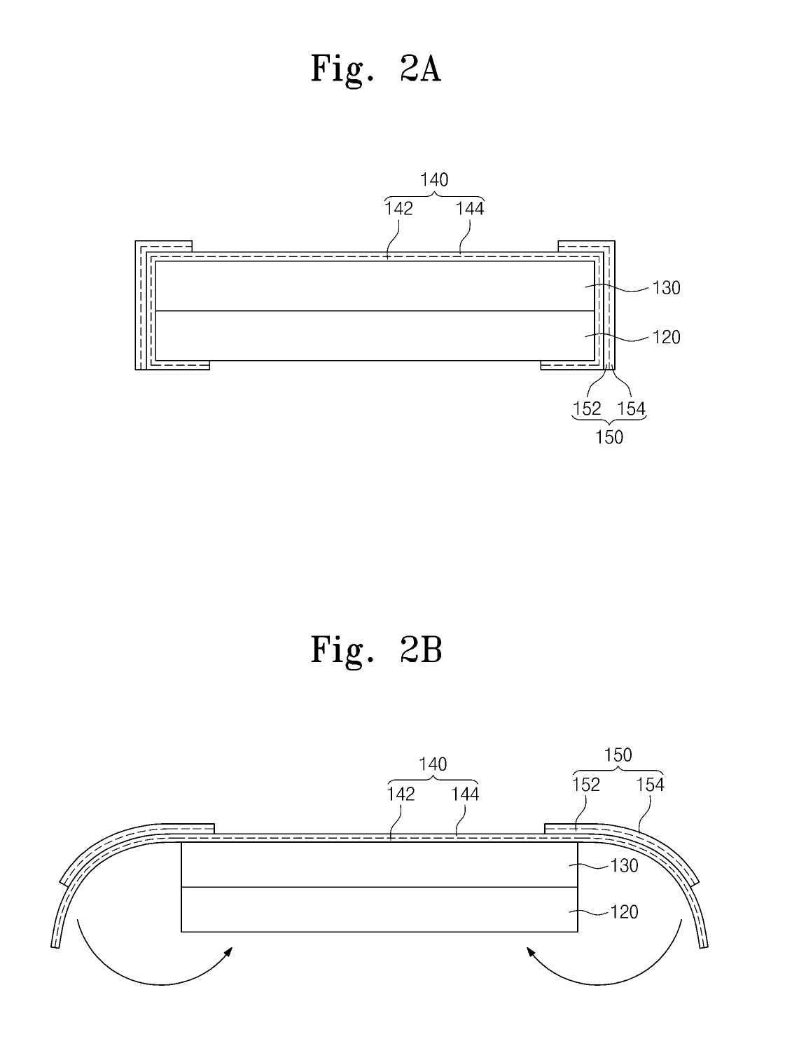

FIG. 2A is a sectional view of an embodiment of a liquid crystal display device. FIG. 2B is a sectional view of an embodiment of a process in which a liquid crystal display panel and a backlight unit are assembled using a packaging tape.

Referring to FIGS. 1, 2A and 2B, the liquid crystal display panel 130 and the backlight unit 120 may be assembled using the packaging tape 140. As shown in FIG. 2B, the packaging tape 140 may adhere to the liquid crystal display panel 130 and the backlight unit 120 while the packaging tape 140 surrounds the crystal display panel 130 and the backlight unit 120. In various embodiments, the packaging tape 140 may surround the top and side surfaces of the liquid crystal display panel 130 and the side surface of the backlight unit 120; it may cover the entire top surface of the liquid crystal display panel 130; it may extend from the side surface of the backlight unit 120 and adhere to at least one portion of an under surface of the backlight unit 120. The packaging tape 140 may thereby improve the strength of the liquid crystal display device 100.

In some embodiments, a light shielding print part 150 adhering on the packaging tape 140 and covering an edge of a top surface of the liquid crystal display panel 130 may be provided. The light shielding print part 150 may prevent light from leaking into a portion at which the image information is not displayed on the liquid crystal display panel 130. The edge of the top surface of the liquid crystal display panel 130 may represent a portion at which the image information is not displayed on the liquid crystal display panel 130. Although the light shielding print part 150 is printed on the packaging tape 140, for convenience of description, the light shielding print part 150 may be separately illustrated in FIG. 1.

The packaging tape 140 may include a first optical adhesive 142 adhering to the liquid crystal display panel 130 and the backlight unit 120 and an optical film 144 disposed on the first optical adhesive 142. The optical film 144 may be formed of PET or triacetylcellulose (TAC). The first optical adhesive 142 may include a resin film having an adhesion force.

The light shielding print part 150 may be formed of substantially the same material as the optical film 144. The light shielding print part 150 may include a white print part 152 and a black print part 154 disposed on the white print part 152. The white print part 152 may have a white color, and the black print part 154 may have a black color. The white print part 152 may reflect against light emitted from the backlight unit 120, and the black print part 154 may block the light passing through the white print part 152.

The light shielding print part 150 may extend from the edge of the top surface of the liquid crystal display panel 130 to cover both side surfaces of the liquid crystal display panel 130. In other embodiments, the light shielding print part 150 may extend from the edge of the top surface of the liquid crystal display panel 130 to cover both side surfaces of the backlight unit 120. Thus, the light shielding print part 150 may more effectively block the light emitted from the backlight unit 120.

Since the light shielding print part 150 is provided, a typical mold frame may be unnecessary. If the mold frame is not used, manufacturing costs of the light crystal display device may be reduced. In some embodiments, the liquid crystal display device may not include the chassis 110 of FIG. 1. Without a chassis, the liquid crystal display device can have a lighter weight and a slimmer profile.

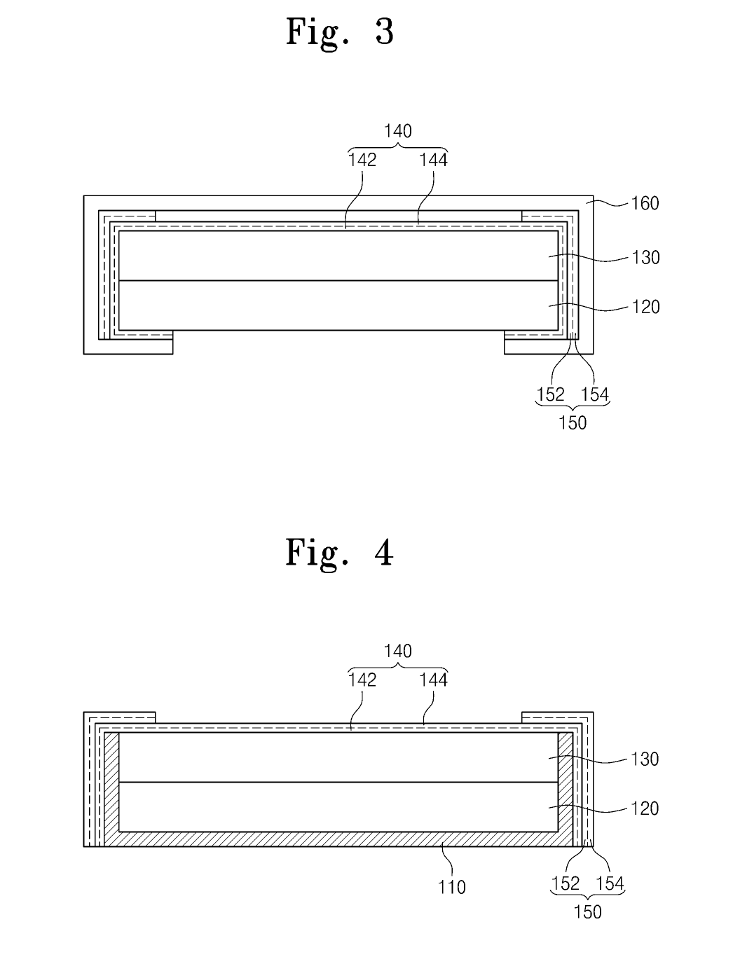

FIG. 3 is a sectional view of another embodiment of a liquid crystal display device. Technical descriptions duplicated with those of the foregoing embodiment described with reference to FIG. 2A will be omitted.

Referring to FIGS. 1 and 3, another embodiment of a liquid crystal display device may further include a second optical adhesive 160 disposed on the optical film 144. The second optical adhesive 160 may include substantially the same material as the first optical adhesive 152, such as, for example, the resin film. The light shielding print part 150 may be disposed between the packaging tape 140 and the second optical adhesive 160. The second optical adhesive 160 may have an adhesion force on both side surfaces thereof. A window (not shown) or a touch screen panel (not shown) may adhere to the second optical adhesive 160.

FIG. 4 is a sectional view of another embodiment of a liquid crystal display device. Technical descriptions duplicated with those of the foregoing embodiment described with reference to FIG. 2A will be omitted.

Referring to FIGS. 1 and 4, a chassis 110 in which the backlight unit 120 and the liquid crystal display panel 130 are assembled is provided. The chassis 110 may be formed of a metal material. The packaging tape 140 may surround the top and side surfaces of the liquid crystal display panel 130 and the side surface of the backlight unit 120. The packaging tape 140 and the light shielding print part 150 may adhere to an outer surface of the chassis 110. The liquid crystal display panel 130 may include an insulation material (not shown) on a portion contacting the chassis 110. The insulation material helps to prevent the backlight unit 120 or the liquid crystal display panel 130 from being electrically shorted to the chassis 110. Another embodiment of the liquid crystal display device may further include the second optical adhesive 160 of FIG. 3 on the optical film 144 of FIG. 4.

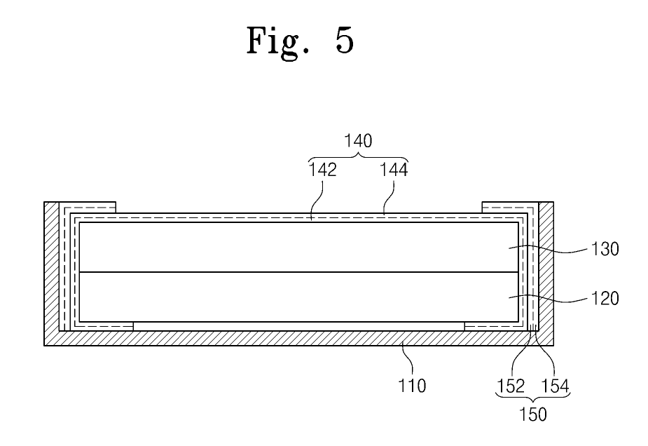

FIG. 5 is a sectional view of another embodiment of a liquid crystal display device. Technical descriptions duplicated with those of the foregoing embodiment described with reference to FIG. 2A will be omitted.

Referring to FIGS. 1 and 5, a chassis 110 in which the backlight unit 120 and the liquid crystal display panel 130 are assembled is provided. The chassis 110 may be formed of a metal material. The packaging tape 140 may surround the top and side surfaces of the liquid crystal display panel 130 and the side surface of the backlight unit 120. The packaging tape 140 may be disposed between the backlight unit 120 and the chassis 110 and between the liquid crystal display device 130 and the chassis 110. The light shielding print part 150 may be disposed between the chassis 110 and the packaging tape 140. The packaging tape 140 may prevent the liquid crystal display panel 130 from being electrically shorted to the chassis 110. In other embodiments, the liquid crystal display device may further include the second optical adhesive 160 of FIG. 3 on the optical film 144 of FIG. 5.

According to various embodiments, the packaging tape 140 may surround the entire top surface and side surface of the liquid crystal display panel 130 and the side surface of the backlight unit. Since the packaging tape is provided, the liquid crystal display panel 130 and the backlight unit 120 may be easily assembled without providing a mold frame. In addition, since the packaging tape 140 has a strong adhesion force, the strength of the liquid crystal display device may be improved.

Additionally, since the light shielding print part 150 is provided, a light leakage phenomenon through the edge of the liquid crystal display panel 130 may be minimized.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A liquid crystal display device comprising:
a liquid crystal panel;
a backlight unit disposed under the liquid crystal panel; and
a packaging tape assembling the liquid crystal display panel and the backlight unit,
wherein the packaging tape surrounds at least a portion of top and side surfaces of the liquid crystal display panel and a side surface of the backlight unit.

2. The liquid crystal display device of claim 1, wherein the packaging tape covers the entire top surface of the liquid crystal display panel.

3. The liquid crystal display device of claim 1, wherein the packaging tape comprises:
a first optical adhesive adhering to the liquid crystal display panel and the backlight unit; and
an optical film on the first optical adhesive.

4. The liquid crystal display device of claim 1, further comprising a light shielding print part adhering to the packaging tape, the light shielding print part covering an edge of the top surface of the liquid crystal display panel.

5. The liquid crystal display device of claim 4, wherein the light shielding print part comprises:
a white print part on the optical film; and
a black print part on the white print part.

6. The liquid crystal display device of claim 4, wherein the light shielding print part extends from the edge of the top surface of the liquid crystal display panel to cover both side surfaces of the liquid crystal display panel.

7. The liquid crystal display device of claim 3, further comprising a second optical adhesive disposed on the optical film.

8. The liquid crystal display device of claim 1, wherein the packaging tape extends from a side surface of the backlight unit to adhere to at least portion of a rear surface of the backlight unit.

9. The liquid crystal display device of claim 1, further comprising a chassis configured to assemble the backlight unit and the liquid crystal display device.

10. The liquid crystal display device of claim 9, wherein the packaging tape adheres to an outer surface of the chassis.

11. The liquid crystal display device of claim 9, wherein the packaging tape is disposed between the chassis and the backlight unit, and between the chassis and the liquid crystal display panel.

12. The liquid crystal display device of claim 1, wherein the backlight unit comprises:
a light source;
a light guide plate on which the light source is assembled;
a reflection sheet disposed on a back surface of the light guide plate; and
an optical sheet on the light guide plate.

13. The liquid crystal display device of claim 12, wherein the light source comprises a light emitting diode.
